(19) United States
(12) Patent Application Publication
(10) Pub. No.: US 2004/0236844 A1
(43) Pub. Date: Nov. 25, 2004

(54) Method and apparatus for remote audiovisual signal recording

(75) Inventor: Sitarama S. Kocherlakota, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Lucent Technologies, Inc.

(21) Appl. No.: 10/839,319

(22) Filed: May 5, 2004

Related U.S. Application Data
(63) Continuation of application No. 09/440,356, filed on Nov. 15, 1999, now abandoned.

(51) Int. Cl. G06F 15/16

(52) U.S. Cl. 709/219

(57) ABSTRACT

A method and apparatus for receiving requests for time scheduled media from a client over the Internet and the delivery of such media programs in a specified streaming video format to the client is disclosed. In a first embodiment the client requests the recording of a media program by a delivery device which delivery device identifies in an e-mail message the storage location of the requested program in the delivery system. The client then accesses the delivery system via the Internet using the storage location identity and the delivery system delivers the stored program. In another embodiment the client requests and receives substantially real time delivery of a requested media program.

### BACKGROUND OF THE INVENTION

This invention relates to the delivery of multi-media signals such as television to clients via computer networks such as the Internet. More particularly, the invention relates to method and apparatus for selectively receiving time scheduled signals from a plurality of sources and at the request of a client for delivering representations of the requested signals to the client with or without recordation and time shifting delay.

In the course of the following description, television signals are mentioned as a most common example but the signals could be any media signals such as broadcast FM, television or any other signals desired by a client. Also, the term “time scheduled signals” is employed to mean any type of signal the presentation of which is known but the control of the time of presentation is not generally controlled by the provider of services herein. Such time scheduled signals may include, broadcast television, broadcast FM, cable television and FM, satellite television and FM signals and closed circuit presentations.

The modern television and FM user has a wide array of possible signal sources available from which to choose. Such sources include standard broadcast television, cable network and satellite systems of many varieties. Each of these systems and others not named require a different type of receiver/decoder and most users have only one or two types of service which they can actually receive. Economically, the user cannot afford to have access to all or even most of the sources of media programming. Further, even when a person can afford to own all of the equipment, much of it will be seldom used and thus not an economic value.

Cable television systems are an attempt to provide full media coverage to households by sharing the costs of receiving many types of signals and delivering those signals to users in a standard format. Although the costs of a cable system can be shared by many users, the bandwidth available for cable revenue is limited so the cable service providers decide on a general basis which media channels will be available to their subscribers. Thus the range of available programs is limited. What is needed in the art is a media delivery system which has shared usage so that many types of signal source formats can be afforded while permitting individual users to specifically request which media programs they want to receive at any given time.

Such a shared media program reception method and apparatus satisfies other needs in the art. Video tape recorder (VTR), which are often video cassette recorders (VCR), are common today and are present in many if not most households. The VTR itself includes many complex mechanical and electrical functions and is subject to many types of well-known failures. Without a back-up VTR at the user's home, a failure may prevent recording a desired program. With a VTR, a viewer can record from broadcast media and play the recording back at a later time. Although most modern VTRs enable some rather sophisticated procedures for recording selected future programs, it appears from the popular press that most households are not capable of using those procedures. The most common use of the VTR is to manually turn on the recording function at the time the program to be recorded is airing or to play pre-recorded tapes. Systems such as VCR+ have been developed which simplify the operation needed for recording future programs but these normally add cost to the recording system and are still too complicated for use in many households. The result is that consumers have not achieved the television viewing freedom they might if recording were less expensive and easier to perform.

Recently, products such as TiVo of Sunnyvale, Calif. (www.TiVo.com) and Replay TV of Mountain View, Calif. (www.ReplayTV.Com) have come into the market, providing a new way of recording broadcast programming at the viewer's location. These systems provide digital storage of incoming TV signals and an improved human/machine interface. Although some advantages are available with known digital storage systems, they still require a per viewing device, e.g. TV, receiver/decoder unit which is costly and subject to failures as are all non-duplicated consumer devices.

What is needed in the art is an improved broadcast media recording system which avoids per viewing device storage equipment and which provides a simplified human/machine interface.

### SUMMARY OF THE INVENTION

A system and method in accordance with the present invention provides broadcast media recording and/or delivery without per viewer location recording media and in so doing avoids the costs and complexity of prior systems. The control of the recording event and the delivery of the media is performed over a computer network such as the well known Internet.

The aforementioned problems are solved and an advance is achieved in accordance with the invention which is a method and apparatus for receiving time scheduled media programs and in response to a request from a client which is remote from the program reception, selecting a specified media program and delivering the selected program to the client via a digital network such as the Internet. An embodiment of the invention includes a delivery system connected to a plurality of media program sources and to one or more clients via the Internet. The media program sources may include cable television systems, satellite transmission systems, CCTV or other sources of media programming. With this wide array of media sources the client has access to ordinary television programming such as soap operas, movies and broadcast sporting events, and to more esoteric media programming such as corporate board meetings or instructional medical procedure programs via CCTV.

In an embodiment, the client contacts the media reception and delivery system via the Internet and specifies which media program he or she would like to receive as well as a streaming video format and data rate at which the program should be sent to the client. The delivery system validates the client request and advises a scheduler portion of the delivery system of the desired program and the delivery format and data rate. The scheduler allocates a receiver to receive the specified media program and an encoder to convert the received program into requested video format. The scheduler begins the receiving and encoding at a time just prior to the scheduled “airing” of the requested media program.

The reception and delivery system may be distributed around the world so that a client may contact a reception and delivery server in one part of the world to control the storage of multimedia signals in another part. For example, a client in Chicago can submit a request for storage of a broadcast television cricket match in India. A reception and delivery system in India can respond to the request by storing the requested cricket match and distributing it to the client. Thus the client has an opportunity to record, view, and/or play back programs not normally accessible to the client.

The encoded media program is stored in digital format in a high speed-high capacity store. When the scheduled time for completion of the requested media program occurs, the reception and encoding stops and the delivery system prepares and sends an electronic mail (e-mail) message to the client identifying one of a plurality of program delivery devices and the address of the file storing the digitized media program. Advantageously, the e-mail to the client includes a URL which identifies both the delivery device and the file address. When the client wishes to receive the stored program he or she transmits on the Internet the URL obtained from the delivery system e-mail. The delivery device of the delivery system responds to the URL by reading the media program from storage and transmitting it to the client over the Internet in the format requested by the client.

In another embodiment, the client may request substantially real time delivery of a requested media program. This delivery type would be used by clients who wish to gain access to programming which may not be otherwise available to the client. That is, the client may not otherwise have access to all of the program sources to which the delivery system is connected. When a client requests substantially real time delivery of a specified media program that program is selected from the sources and digitally encoded in a manner similar to the previously discussed embodiment. The client, however, is quickly notified of the URL of the media program file being stored and the start address of the file is adjusted when the client accesses it so that only a short time delay, such as 0.5 second to 10 minutes, is present between the file address being written and the file address being delivered to the client.

### BRIEF DESCRIPTION OF THE DRAWINGS

A more complete understanding of the invention may be obtained from consideration of the following description in conjunction with the drawing, in which:

FIG. 1 is a block diagram of Internet connected apparatus for media program delivery to clients;

FIG. 2 is a block diagram of a delivery system shown in FIG. 1;

FIG. 3 represents a video screen presented to a client during membership sign-up;

FIG. 4 represents a video screen presented to a client for requesting delivery of a specific media program;

FIG. 5 is a flow diagram of the operation of the media delivery system;

FIG. 6 is a flow diagram of a storage routine of the media delivery system for time shifting recording;

FIG. 7 is a flow diagram of a storage routine of the media delivery system for “substantially real time” delivery; and

FIG. 8 is a block diagram of a distributed media delivery system comprising a plurality of media delivery units.

### DETAILED DESCRIPTION

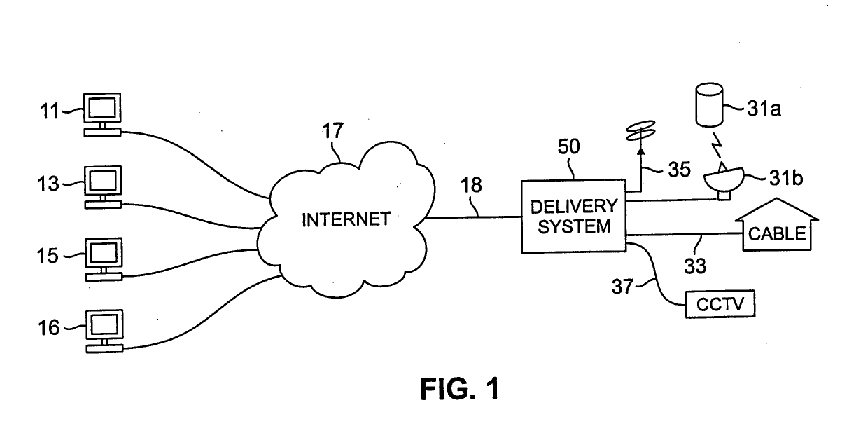

FIG. 1 shows a system for accepting requests for recording and/or presentation of media programming from a plurality of clients 11, 13, 15 and 16 and for delivering media programming to those clients. In FIG. 1, client 11 is connected to the Internet 17 via an analog modem and has a maximum data throughput of 56K bps. Client 13 is connected to the internet via an XDSL connection and has a data throughput of approximately 6M bps and client 15 is connected via a LAN and has a data throughput of 10 to 100 M bps. Lastly, client 16 is connected to the Internet via a cable modem. Although the Internet is used as a communication device in the present embodiment, the present method and apparatus could operate with any type of digital network.

The clients 11, 13, 15 and 16, which represent a large number of possible clients, are connectable via the Internet 17 and a network connection 18 to a media delivery system 50. The delivery system 50 interacts with the clients 11, 13, 15 and 16 to receive media delivery requests from the clients and to deliver media programs to those clients. The media to be delivered and/or recorded may comprise satellite transmitted television 31a and 31b of all varieties, cable television feed cables 33, feeds from standard broadcast television and FM signals 35 and other media signal sources 37, such as closed circuit television. In the present embodiment of the signal sources 31-37, convey media programming in a standard format and the media programming is provided at the source on a known time schedule. Media signals from the sources 31-37 are selected on the basis of requests from the clients 11-16 and are delivered by the delivery system 50 to the clients in formats specified by the client. When the delivery system 50 begins to selectively receive media programming, the clients access the media over the Internet 17 and the network connection 18.

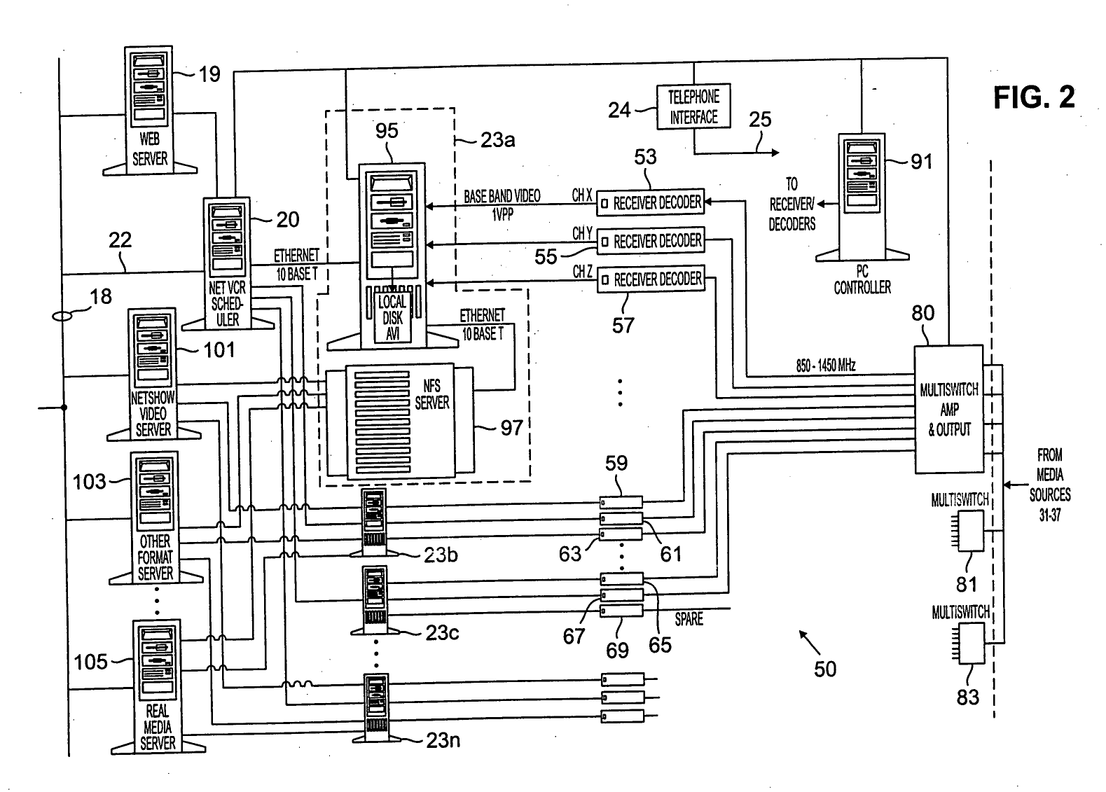

FIG. 2 represents the apparatus employed by a delivery system 50 and includes a request server 19 connected by network connection 18 to the Internet 17. Request server 19 is the initial interface with the client and accordingly, its URL is the “home” URL of the delivery system. The request server 19 communicates client requests to a scheduler 20 which responds to the requests by overseeing the operations of the delivery system 50 to select specified programming and make it available to the clients. Scheduler 20 maintains current and future information regarding the schedule of media programs available on the various media sources, e.g. 31a-37 and their times of availability. The primary sources of such scheduling information can be accessed via the Internet 17 which is available on connection 22.

When a media program requested by a client is playing or is about to play, scheduler 20 connects the signal source conveying the program to a receiver/decoder such as receiver/decoder 53 which is appropriate for the signal source to produce a standard base band signal of the selected media program. As is shown in FIG. 2, a plurality of receiver/decoders 53-69 is present in the embodiment. For example, if a channel X from satellite 31a is to be made available to a client, e.g. 15, scheduler 20 transmits a connection request to a multiswitch such as multiswitch 80, to connect the source signals from satellite 31a to a specified receiver/decoder, e.g. 55, for signals from that satellite. Multiswitch 80 responds to the request by connecting the signals to the specified receiver/decoder, e.g. 55. At the same time, scheduler 20 sends a receiver/decoder command to a receiver controller 91 specifying that channel X is to be converted by receiver 55 into base band. In the present embodiment, each receiver/decoder, e.g. 55, can produce a base band output signal for one video channel at a time. Accordingly, a delivery system for simultaneous delivery and/or recording of 200 video channels would include at least 200 receivers/decoders. The receiver controller 91 is connected to all of the receivers/decoders 53-69, and transmits to them the necessary parameters to receive and/or decode the signals from the specified source, e.g. 31a, into video base band. The operation of such digitally controlled receivers/decoders is well known and not described in detail.

The video base band output signals of each receiver/decoder, 53-69, are connected to a predetermined one of a plurality of video digitizers 23a through 23n. The video digitizers of the present embodiment are 450 MHZ Pentium II NT work stations and which are each connected to three base band video signal inputs from the receiver/decoders. In other embodiments, the digitizers may be less capable and perhaps be connected to only a single receiver/decoder. Similarly, more capable video digitizers may be connected to more than three receiver/decoders.

Each video digitizer comprises a high capacity processor 95 and a high capacity storage device 97, such as the Sun Solaris box storage array 5000. The processor, e.g. 95, receives each of the incoming base band video signals from its connected receiver/decoders, e.g. 53, 55 and 57, and converts each received signal into an uncompressed AVI format. The uncompressed AVI is then converted into a format specified by a client in the original request from the client. The converted video/audio signal is then stored in a file on storage device 97 for replay to the requesting client. It should be mentioned that actions by the processor 95 occur in response to directions from the scheduler 20.

Delivery system 50 also includes a plurality of playback servers of which playback servers 101, 103 and 105 are shown in FIG. 2. Each playback server has one or more Internet addresses and is connected to retrieve stored files from the high capacity stores, e.g. 97, of all of the video digitizers, e.g. 23. The software control of the playback server responds to requests from clients for a particular URL including a file identity by retrieving the video represented by the URL from a predetermined high capacity store and transmitting streaming video derived from the video file to a requesting client. The high capacity store storing each recorded video program is identified to the playback servers 100, 103 and 105 by the scheduler 20 as is the address of the particular file.

Advantageously, the playback to a client occurs in one of the streaming video format which the client can receive. When a client first requests a media program from request server 19, the desired streaming video format is specified with the request. The scheduler 20, in response to the request information, identifies the requested playback format to the video digitizer selected to record the video program. The video digitizer then converts the compressed AVI of the video program into the requested format before storage in a high capacity store.

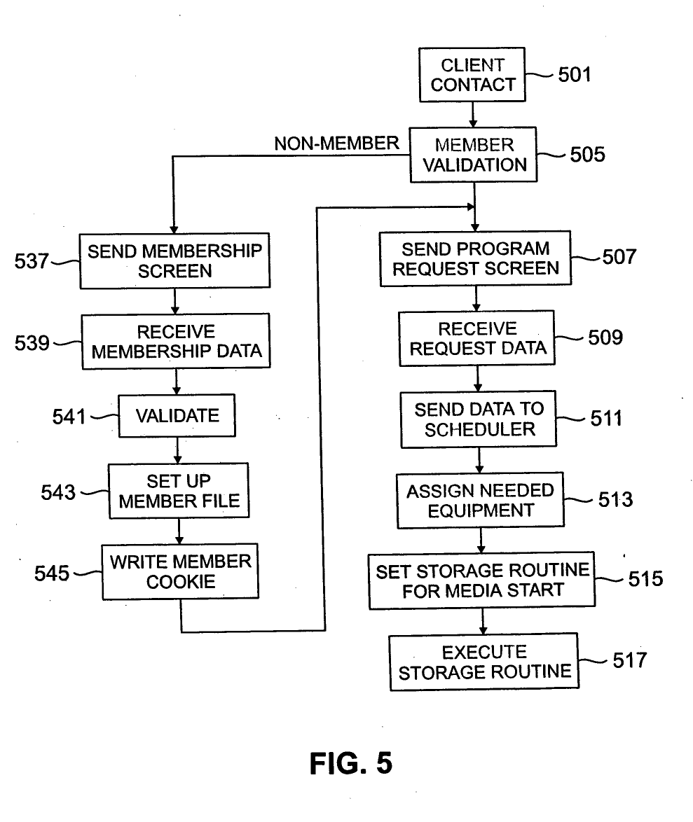

FIGS. 5-7 are flow diagrams representing the sequence of interactions between a client, e.g. 15, and the delivery system 50 and the operations of the components of the delivery system performed to deliver a requested media program to the client. Although the emphasis in this description is the delivery of video programs such as television, it must be kept in mind that the media programs delivered may be audio or video and that the video programs may include an audio portion.

In the present embodiment, a client must become a service member prior to making requests for media delivery. Such membership allows the delivery system to record certain default parameters for media delivery and allows the delivery system to establish a method of payment for services, if such is desired. In other embodiments such memberships may not be required and the client may merely contact the request server 19 and request media delivery and/or storage.

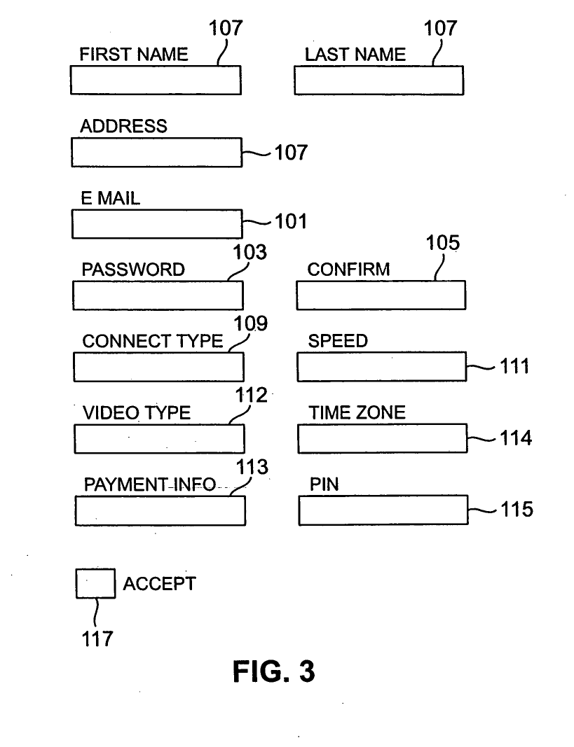

A client, e.g. 15, may contact the request server 19 at any time using a widely distributed URL to the service provider's home page. When a client contacts the request server (step 501 FIG. 5) prior to becoming a member, a step 505 is performed to identify if the client is a non-member and a screen is presented (step 573) to the client asking whether the non-member client would like to become a member. If so, the client is presented with a screen of information boxes as shown in FIG. 3, a portion of which may constitute terms and conditions of membership (not shown). The client, after viewing the terms and conditions, enters his or her name and address into boxes 107 and his or her e-mail address into a text box 107. In the present embodiment a client's e-mail address is used as a log-in name for services, however, other embodiments may include a separate new text box for a separate log-in name. The client then enters in a text box 103 a password for later permission to use the service and confirms the password by retyping it in a confirmation box 105. The client also enters his or her connect type such as XDSL in a text box 109 and connect speed, e.g. 6 M bps in box 111. The client further specifies in a text box 112 the video format he or she would like to use to receive later requested signals. Lastly, the client enters payment information such as a credit card number in text box 113. After the boxes are filled in, the client clicks on accept button 117 and the information is sent to the request server 19 as membership data validates the data in a step 541 and stores necessary parameters in a client membership file in a step 543. After information validation the request server 19 returns a “thank you new member” screen to the client. The request server also sets a cookie (step 545) on the client computer to show that membership permission has been granted to the client.

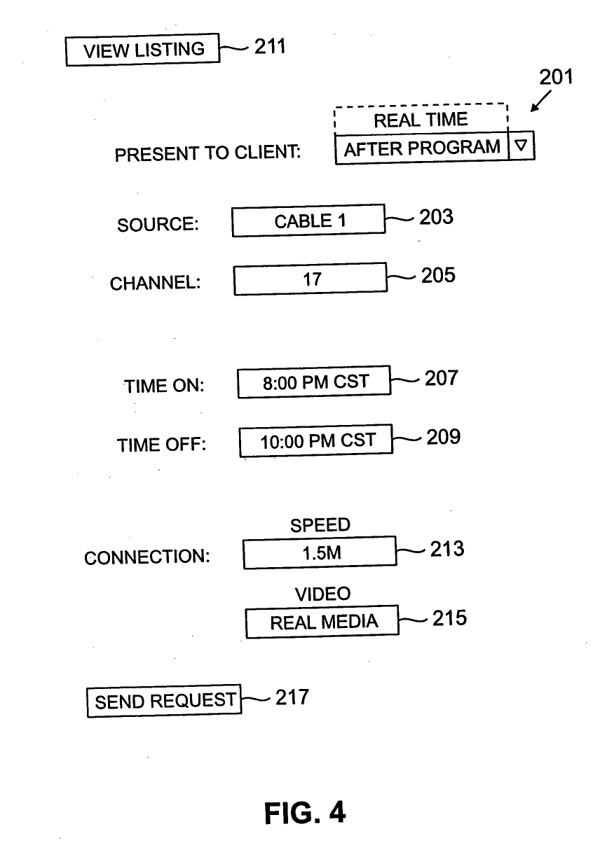

A client who is a member is free to enter the URL of the request server 19 and be connected by the Internet to the request server 19 which will recognize the member status. Upon recognizing that the client is a member by entry of the client's password, and checking the client's cookie, the request server returns a program request screen (step 507 FIG. 5) to the client. Such a request screen, as is shown in FIG. 4, is used by the client to request a specific media program for delivery to the client. In the present example, the client requests in text box 201 that the media program be recorded for later viewing. The client also uses the screen of FIG. 4 to identify the program to be recorded. As shown, the client enters the program source, e.g. cable 1, into text box 203, the channel, e.g. 17, into text box 205, and the time-on and off into text boxes 207 and 209, respectively. As an aid to the client a click button 211 is also provided which, when clicked, requests a program listing to be presented to the client. Finally, if the client wishes to use a different connection speed and streaming video type than that established on the membership form (FIG. 3) such values can be entered into text boxes 213 and 215. At the completion of data entry on the screen of FIG. 4, the client clicks a button 217 and the request data is sent to the request server 19 for use in preparing the requested media program for delivery to the client.

It should be mentioned that other arrangements for selecting media programs may also be used in other embodiments. For example, the client may be presented with a complete searchable listing of all programs and times available. The client might then merely click on a desired media program and the source, channel and times of the clicked program will be recorded. Further, the program selection might include a printed text with VCR+ numbers or the like relating to the individual receivable programs. In that instance, the client would merely enter the VCR+ number on a screen provided and the delivery system 50 would identify the source and time from that number. Thus, it can be seen that many manners of identifying a media program to the request server are encompassed by the disclosed system. Regardless of the method of program identification, the request server 19 should, after a request is made, have enough information to select the appropriate program from its sources and to properly encode that program for delivery to the client.

In the present example the requested media program is to be stored by the delivery system 50 for later presentation to the client, e.g. 15. Upon receipt of a program storage request in step 509 the request server forwards (step 511) to the scheduler 20 the identity of the program to be stored, the identity (e-mail address) of the requesting client, the data rate of the client and the type of streaming video delivery desired by the client. The scheduler 20 analyzes the information from the request server 19 in a step 513 and schedules the availability of a receiver/decoder, e.g. 53, and video digitizer, e.g. 23a, during the time that reception and storage is to take place. A storage routine is then scheduled in step 515 to execute on the scheduler 20 at a time just prior to the time at which storage is to begin, i.e. just prior to the scheduled start of the requested media program.

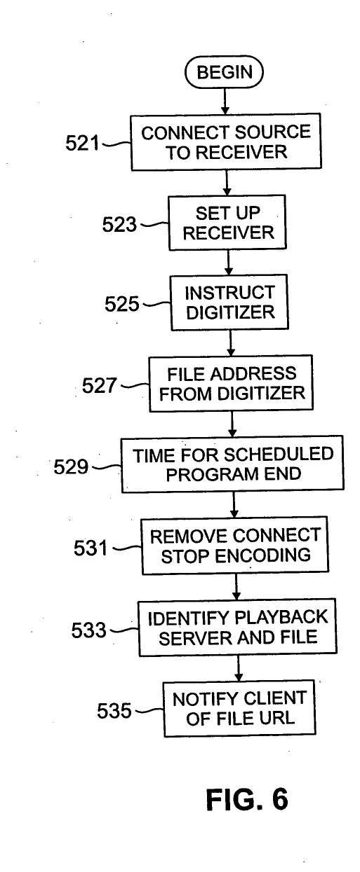

Upon execution, the storage routine (FIG. 6) communicates with the devices scheduled to perform the requested program selection, encoding and storage. Initially, the scheduler 20 in step 521 transmits data to a multiswitch 80 a direction to connect cable 1 to the decoder/receiver, e.g. 53, previously allocated to the scheduler. At about the same time, scheduler 20 transmits a command in step 523 to controller 91 specifying that it is to control receiver/decoder 53 to convert channel 17 of the signals from cable 1 into baseband. The scheduler 20, as a part of the storage routine, also identifies the client's data rate and streaming media format to the digitizer 23a and directs in step 525 the encoding of base band signals from receiver/decoder 53 into uncompressed AVI and conversion of the result into Real Media. The processor 95 of the digitizer 23a then stores the Real Media data stream as a file on store 97 and identifies the beginning file address to scheduler 20.

The scheduler then begins a timer in step 529 for the storage routine which times out at the scheduled end of the media program being stored. At time out the scheduler directs in step 531 the removal of connections established to receive the requested program and directs the digitizer 23a to stop the encoding and storage of the program. The storage routine then performs step 533 to identify a playback server, e.g. 105, to transmit the stored media program to the client upon the client's request. In the present example playback server 105 is identified because it provides streaming video in the Real Media format. Upon identifying the playback server 105, the scheduler 20 produces and sends (step 535) an e-mail message back to client 15 which message identifies by URL the identified playback server 105 and the file to be accessed. As an example, the URL might be:

HTTP://www.playbackserver105.com/newrecord

where newrecord identifies the address of the media program file.

The client 15 receives the e-mail from the scheduler and, at a time selected by the client, accesses URL HTTP://www.playbackserver105.com/newrecord. The playback server 105 responds to the URL by accessing the Real Media file stored for client 15 in memory 97 and forwarding that file to client 15 via the Internet.

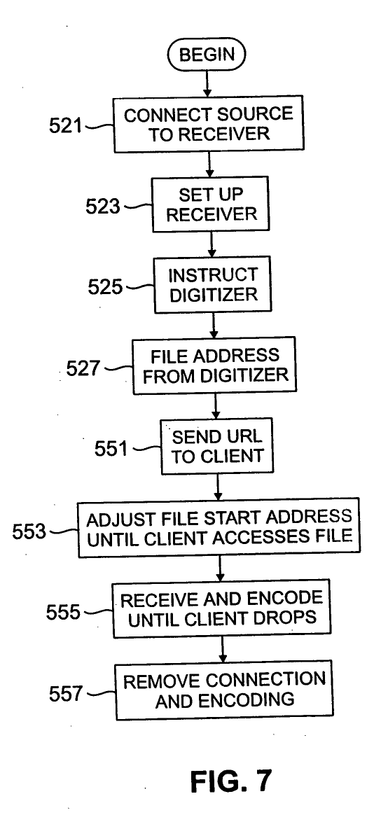

In the preceding example the client selected a media program for storage and delivery after the scheduled end of the media program. The client may also request a substantially real time delivery of a media program to thereby take advantage of the broad spectrum of available programs from the delivery system. To begin the substantially real time delivery, the client will select “real time” in the “present to viewer” text box of FIG. 4. The remainder of the channel selection and connection data will remain substantially the same as in FIG. 5 with the prior example. That is, the scheduler 20 responds to the client's request by scheduling the recording of a specified program in a high speed store, e.g. 97, in a format requested by the client. The storage routine of FIG. 6 is modified after the performance of step 527. In the substantially real time delivery (FIG. 7) a step 551 is performed after step 527. In step 55, the URL of the stored media file is returned quickly to the client by e-mail so that the client can rapidly access the delivery server. The media program file start address data of the delivery server is continuously updated in a step 553 so that whenever the file reading URL is received from the client the file start address will be separated from the address presently being written by only a brief amount of media program viewing time. The brief amount may range from 0.5 second to 10 minutes so that a client may view the media program with only 0.5 second to 10 minute delay from when it was presented at the media source. The delay interval of 0.5 second to 10 minutes is considered herein to provide substantially real time viewing by the client. When the client drops (step 555) the present connection through the Internet, the scheduler responds in step 557 by deleting the connections and encoding within the delivery system 50.

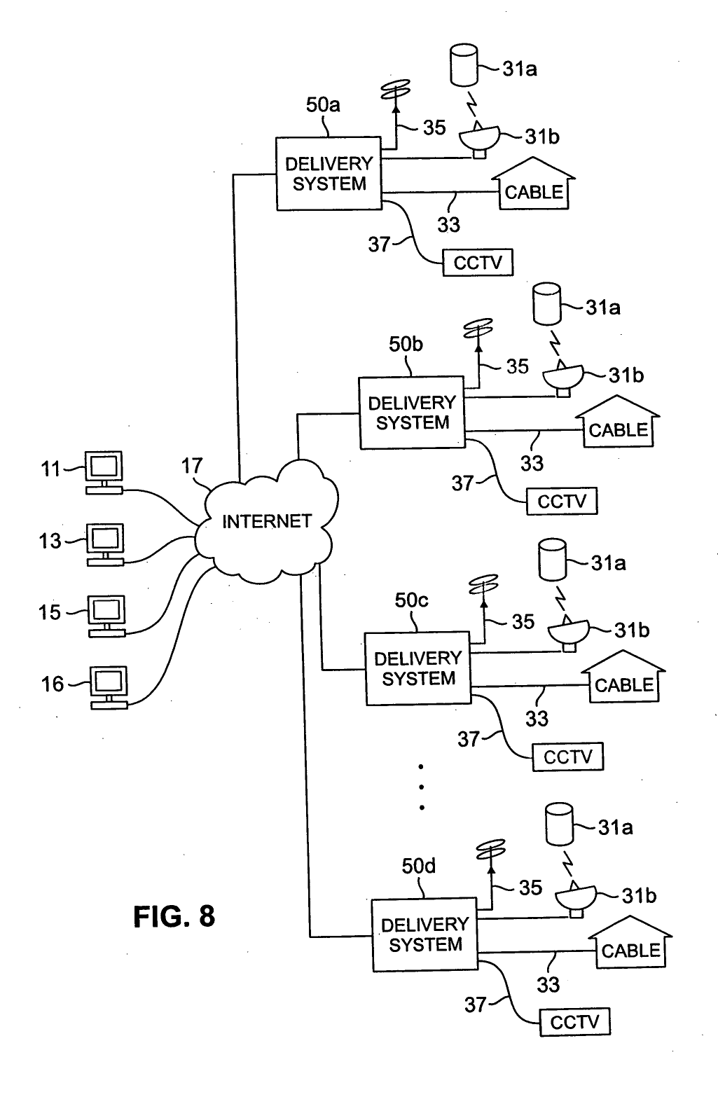

FIG. 1 shows a single delivery system 50 connected by the Internet to many clients. FIG. 8 shows an embodiment in which a plurality of delivery systems, e.g. 50a, 50b, 50c and 50d, which represent a possibly large number of delivery systems, are also shown connected to the clients 11-16 via the Internet. The delivery systems 50a-50d may be widely distributed around the world to give clients access to broadcast multimedia which is available in one region of the world and not in others. Delivery system 50a may be in San Francisco and delivery system 50d may be in Norway. A client in Chicago, for example, can access a delivery system and direct the storage of a San Francisco Forty-Niners football game and a Norwegian hockey match. The programs will be stored at their respective locations to be accessed via the Internet by the requesting client. In FIG. 8, each of the delivery systems 50a-50d has its own network URL and is substantially the same as the delivery system of FIG. 2. A client, e.g. 15, may direct a request for a multimedia program from delivery system 50a. The request is received by the request server 19 of delivery system 50a, which transmits data representing the request to the associated scheduler 20. Schedulers 20 each maintain a list of the multimedia programs available at the delivery system (50a) containing the scheduler and lists of the multimedia programs available at others of the delivery systems (50b-50d). When a requested program is available at the delivery system receiving the request, the storage and delivery of the program is performed as described with regard to the embodiment of FIG. 1. Alternatively, when the requested program is not available at the delivery system receiving the request, the scheduler 20 identifies which of the delivery systems, e.g. 50d, has access to the requested program. A message is then forwarded via connection 22 and the Internet 17 to a scheduler 20 of the delivery system 50d which has access to the requested program. The scheduler 20, of delivery system 50d, upon receiving the forwarded request, controls the delivery system 50d to store the requested program and notifies the client 15 of the URL at which the program can be accessed.

The preceding description discloses that original client contact with the delivery system is via a digital network such as the Internet. The delivery system may also include a telephone interface 24 for clients which do not want to use a digital network to order the reception and storage of a media program. The telephone interface 24 is connected to the standard telephone network via a connection 25 and includes a microprocessor controlled voice and tone responsive apparatus for receiving and interpreting client telephone signaling. Such voice and tone responsive apparatus is known in the art and not described in detail herein. In order to validate incoming telephone requests, it will first be necessary to assign a login number and a password or pin to the client for telephone ordering. Such login and password or pin will be presented at the time of membership approval to those clients who desire telephone access.

When a client wishes to request storage or a program via the telephone, he or she places a call using a public phone number to which the telephone network responds by connecting the client to telephone interface 24. Telephone interface 24 responds to the call by presenting announcements, receiving the login and validating pin or password and by validating the client's access. After access is validated, the interface is set to receive directions from the client via DTMF tones or via voice. The client directions specify the particular program to be stored. After the program specifying directions are received, the telephone interface communicates those directions along with the client login to the scheduler 20 which responds thereto in the manner discussed in detail above by controlling the delivery system 50 to store the requested program in a digital format requested by the client at the time of membership. As with the preceding description, the scheduler sends an e-mail to the client's e-mail address advising that the program has been stored and the particular Internet address to use to access the file. The client then accesses the stored program over the Internet using the e-mail provided address.

It is understood that the above described embodiments are merely descriptive of the principles of the invention and that many variations may be devised by those skilled in the art without departing form the scope of the invention. It is intended that such variations be included within the scope of the claims.

What is claimed is:

1. A method of remote media program recording via a computer network comprising:
providing a plurality of media programs;
receiving from a client via the computer network, a request to deliver a specified media program to the client, the request specifying a format for delivery;
selecting and storing in digital format the media program specified by the client; and
sending to the client, via the computer network, a message identifying a computer network address from which the stored media program can be accessed.

2. A method in accordance with claim 1 comprising receiving from the client via the computer network a request for access to the stored media program.

3. A method in accordance with claim 1 comprising transmitting the stored media program to the client via the computer network in the format specified during request receiving.

4. A method in accordance with claim 1 wherein the digital format for storing the specified media program is a format compatible with the format specified during request receiving.

5. A method in accordance with claim 1 wherein the specified format is a streaming video format.

6. A method in accordance with claim 5 wherein a plurality of streaming video formats are provided and the computer network address sent to the client identifies a server capable of providing streaming video in the format requested by the client.

7. A method in accordance with claim 1 wherein the media program is of predetermined time duration and the message sent to the client is sent after the time duration of the media program has passed.

8. A method in accordance with claim 3 wherein the program transmitting occurs while the selecting and storing is occurring.

9. A method in accordance with claim 8 wherein the message identifying a computer network address is sent to the client at substantially the same time that the selecting and storing begins so that the media program can be delivered to the client substantially in real time.

10. A remote media program recording and replay system for use over a computer network comprising:
a plurality of media program signals each representing a media program;
a plurality of media delivery devices, each media delivery device for providing stored media programming in a predetermined format over the computer network;
a server for receiving via the computer network a recording request from a client, the recording request specifying a media program and a delivery format in which the client desires to receive the media program;
selecting and converting apparatus for selecting the specified media program from the plurality of media program signals and for converting the selected media program into a digital format;
storage apparatus for storing the selected media program in the digital format provided by the selecting and converting apparatus;
notifying apparatus responsive to the completion of storage of the specified media program by the storage apparatus for notifying the client of a computer network address specifying one of the media delivery devices and a data file of the storage apparatus storing the specified media program; and
the media delivery device, being responsive to a delivery request from the client received via the computer network for transmitting the stored media program to the client via the computer network.

11. A media program recording and replay system in accordance with claim 10 wherein at least one of the plurality of media program signals represents a time based broadcast signal and the recording and replay system comprises:
a scheduler which is responsive to a recording request and broadcast time information for selecting a specified media program.

12. A media program recording and replay system in accordance with claim 10 wherein the media program requested by the client is a television broadcast of a sporting event.

13. A media program recording and replay system in accordance with claim 10 wherein the media program requested by the client is a motion picture.

14. A media program recording and replay system in accordance with claim 11 wherein the system prepares for delivery to a client only media programs or portions of media programs broadcast after the receipt by the web server of the request from a client.

15. A media program recording and replay system in accordance with claim 10 wherein the storage apparatus stores the media program in an uncompressed digital format.

16. A media recording and replay system in accordance with claim 10 wherein at least one of the media delivery devices delivers media programs in a streaming video format.

17. A media recording and replay system in accordance with claim 16 wherein the streaming video format is real media.

18. A media recording and replay system in accordance with claim 16 wherein the streaming video format is net show video.

19. A remote media program delivery system for use over an internet comprising:
a plurality of time scheduled media program signals each representing a media program;
a plurality of internet media delivery devices, each media delivery device for transmitting media programming in a predetermined format over the internet;
a server for receiving via the internet a media program request from a client, the media program request specifying a media program and a digital delivery format in which the client desires to receive the media program;
selecting and converting apparatus for selecting the specified media program from the plurality of time scheduled media program signals and for converting the selected media program into a digital format;
storage apparatus for storing in a data file at least a portion of the selected media program in the digital format specified by the client to the server;
notifying apparatus for notifying the client of an internet address specifying one of the internet media delivery devices and a data file of the storage apparatus storing at least a portion of the specified media program; and
the media delivery device, being responsive to a delivery request from the client received via the internet for transmitting the media program from the storage apparatus to the client via the internet.

20. A media program delivery system in accordance with claim 19 wherein at least one of the plurality of media program signals represents a time based broadcast signal and the media program selecting system comprises:
a scheduler which is responsive to a media program request and scheduled broadcast time information for selecting a specified media program.

21. A media program delivery system in accordance with claim 19 wherein at least one of the media delivery devices delivers media programs in a streaming video format.

22. A media program delivery system in accordance with claim 21 wherein the streaming video format is real media.

23. A media program delivery system in accordance with claim 21 wherein the streaming video format is net show video.

24. A media program delivery system in accordance with claim 19 wherein the specified media program is a television broadcast of a sporting event.

25. A media program delivery system in accordance with claim 19 wherein the specified media program is a motion picture.

26. A media server comprising:
a plurality of media program signals each representing a media program;
a plurality of media delivery devices, each media delivery device for providing stored media programming in a predetermined format over a computer network;
a request apparatus for receiving via a computer network, a storage request from a client, the storage request specifying a media program and a delivery format in which the client desires to receive the media program;
apparatus for selecting the specified media program from the plurality of media program signals and for storing the selected media program in a digital format compatible with the specified delivery format; and
notifying apparatus for notifying the client of a computer network address identifying the stored media program.

27. A media server in accordance with claim 26 comprising a media delivery device responsive to a delivery request from the client received via the computer network for transmitting the stored media program to the client via the computer network.

28. A media server in accordance with claim 26 wherein at least one of the plurality of media program signals represents a time based broadcast signal and the media server comprises:
a scheduler which is responsive to a storage request and broadcast time information for selecting a specified media program.

29. A media server in accordance with claim 28 wherein the media server prepares for delivery to a client only media programs or portions of media programs broadcast after the receipt by the server of the request from a client.

30. A media program storage system comprising:
a plurality of media program receivers, each including access to a plurality of media program signals, at least one media program signal being accessible at less than all of the plurality of media program receivers;
request serving apparatus responsive to a storage request from a client for storage of a media program signal identified by the client for sending the request for storage to a media program receiver having access to the media program requested; and
storage apparatus at the media program receiver receiving the storage request sent from the request apparatus for storing the requested multimedia program.

31. A media program storage system in accordance with claim 30 wherein the request serving apparatus stores accessability data representing the accessability of media program signals at the media program receiver.

32. A media program storage system in accordance with claim 31 wherein the request server analyzes the accessability data to identify a media program receiver having access to the media program requested.

33. A media program storage system in accordance with claim 30 wherein the media program receiving arrangement receiving the storage request notifies the client originating the request that the requested storage has occurred.

34. A media program storage system in accordance with claim 33 wherein the media program receiving arrangement receiving the storage request receives a request from the client for delivery of the stored media program and delivers the stored media program to the client in streaming video format over the computer network.
